(19) United States
(12) Patent Application Publication
(10) Pub. No.: US 2023/0374418 A1
(43) Pub. Date: Nov. 23, 2023

(54) LAUNDRY COMPOSITION COMPRISING SPORES

(71) Applicant: The Procter & Gamble Company, Cincinnati, OH (US)

(72) Inventor: Neil Joseph LANT, Newcastle upon Tyne (GB)

(21) Appl. No.: 18/319,697

(22) Filed: May 18, 2023

(30) Foreign Application Priority Data
May 19, 2022 (EP) 22174452.7

(51) Int. Cl. C11D 3/38; C11D 1/83; C11D 3/34; C11D 3/20; C11D 11/00; C11D 3/386

(52) U.S. Cl. CPC C11D 3/381; C11D 1/83; C11D 3/3418; C11D 3/2003; C11D 11/0017; C11D 3/386

(57) ABSTRACT

A concentrated laundry composition which is dilutable in water to form a liquid laundry detergent composition wherein the concentrated composition includes a high level of surfactant, bacterial spores, and optionally a rheology modifier.

### FIELD OF THE INVENTION

The present application is in the field of laundry compositions. In particular, it is directed to a concentrated laundry composition comprising bacterial spores. It is also related to a method of doing laundry by diluting the concentrated composition. The composition and method of the invention provide sustained reduction and/or prevention of malodor on fabrics.

### BACKGROUND OF THE INVENTION

Malodor on fabrics even after they have been washed seem to be a recurring problem. Bacterial endospores, hereafter referred to as ‘spores’, have been reported to offer anti-malodor benefits in laundry compositions. However, this presents a challenge of keeping the spores stable and in a dormant state on storage without impacting their ability to germinate and grow once the product has been used. For example, interventions to improve spore storage stability come with a risk that they will slow down subsequent germination and/or growth. There is a need for a product in which the spores are stable in product but are quick to germinate when the product is used.

Sometimes it is desirable to have the compositions in concentrated form to reduce packaging and transport costs and to reduce environmental impact. The concentrate should be stable on storage and it should also be stable when diluted in water of different hardness. Thus, there is also a need for a composition that is stable as a concentrate (physical & chemical stability) and does not become unstable when diluted.

### SUMMARY OF THE INVENTION

According to one aspect, there is provided a concentrated laundry composition. The concentrated laundry composition is dilutable in water to form a liquid laundry detergent composition. The concentrated composition comprises a) from 10 to 85% by weight of surfactant, preferably from 22 to 80%; b) a rheology modifier, preferably from 5 to 20% by weight of the composition; and c) from about 1×10² to about 1×10⁹ CFU/g of the composition of bacterial spores.

According additional aspects, there is provided a method of doing laundry by diluting the concentrated composition of the invention to make a ready to use detergent. The method of the invention provides sustained malodor removal and/or malodor prevention from fabrics over an extended period of time.

Another aspect includes a composition comprising: a) from 22 to 80% by weight of surfactant; b) from 5 to 20% by weight of a rheology modifier; and c) from about 1×10² to about 1×10⁹ CFU/g of the composition of bacterial spores.

An additional aspect includes a composition comprising: a) from 25 to 75% by weight of surfactant; b) from 5 to 10% by weight of a grafted copolymer of an acrylic polymer and fatty alcohol alkoxylates, or its salts, or a mixture thereof; and c) from about 1×10² to about 1×10⁹ CFU/g of the composition of bacterial spores.

The elements of the invention described in relation to any aspect apply mutatis mutandis to the other aspects of the invention.

### DETAILED DESCRIPTION OF THE INVENTION

Included herein is a concentrated laundry composition to be diluted before use. The composition provides biotics benefits, in particular it provides long-lasting malodor reduction and/or prevention.

Also included herein is a method of doing laundry using a concentrated composition of the invention, the method includes dilution of the concentrate to make a diluted laundry detergent. Preferably, the method comprises the step of contacting a fabric with a washing liquor comprising at least 1×10² CFU/liter of the liquor, preferably from about 1×10² to about 1×10⁸ CFU/liter of the liquor, preferably from about 1×10⁴ to about 1×10⁷ CFU/liter of the liquor, of bacterial spores, preferably Bacillus spores.

As used herein, the articles “a” and “an” when used in a claim, are understood to mean one or more of what is claimed or described. As used herein, the terms “include,” “includes,” and “including” are meant to be non-limiting. The compositions of the present disclosure can comprise, consist essentially of, or consist of, the components of the present disclosure.

All percentages, ratios and proportions used herein are by weight percent of the composition, unless otherwise specified. All average values are calculated “by weight” of the composition, unless otherwise expressly indicated. All ratios are calculated as a weight/weight level, unless otherwise specified.

All measurements are performed at 25° C. unless otherwise specified.

Unless otherwise noted, all component or composition levels are in reference to the active portion of that component or composition, and are exclusive of impurities, for example, residual solvents or by-products, which may be present in commercially available sources of such components or compositions.

### Composition

The present disclosure relates to a concentrated laundry composition. The “concentrated laundry composition” is herein sometimes referred as “the composition of the invention”.

The composition is liquid form. The composition may include from about 15% to about 70%, by weight of the composition, of water. The pH of the composition may be optimized to facilitate bacterial spores stability.

The composition may be in the form of a unitized dose article, such as a pouch. Such pouches typically include a water-soluble film, such as a polyvinyl alcohol water-soluble film, that at least partially encapsulates a composition. Suitable films are available from MonoSol, LLC (Indiana, USA). The composition can be encapsulated in a single or multi-compartment pouch. A multi-compartment pouch may have at least two, at least three, or at least four compartments. A multi-compartmented pouch may include compartments that are side-by-side and/or superposed. Pouched compositions may have relatively low amounts of water, for example less than about 20%, or less than about 15%, or less than about 12%, or less than about 10%, or less than about 8%, by weight of the detergent composition, of water.

### Bacterial Spores

The composition can comprise from about 1×10² to about 1×10⁹ CFU/g, preferably from 1×10³ to about 1×10⁷ CFU/g and more preferably from 1×10⁴ to about 1×10⁷ CFU/g of the composition of Bacillus spores.

The bacterial spores for use herein: i) are capable of surviving the temperatures found in a laundry process; ii) are fabric substantive; and iii) have the ability to excrete enzymes. The spores have the ability to germinate and to form cells after the concentrated composition has been diluted and used in a laundry process. The spores can be delivered in liquid or solid form. Preferably, the spores are in solid form.

Some gram-positive bacteria have a two-stage lifecycle in which growing bacteria under certain conditions such as in response to nutritional deprivation can undergo an elaborate developmental program leading to spores or endospores formation. The bacterial spores are protected by a coat consisting of about 60 different proteins assembled as a biochemically complex structure with intriguing morphological and mechanical properties. The protein coat is considered a static structure that provides rigidity and mainly acting as a sieve to exclude exogenous large toxic molecules, such as lytic enzymes. Spores play critical roles in long term survival of the species because they are highly resistant to extreme environmental conditions. Spores are also capable of remaining metabolically dormant for years. Methods for obtaining bacterial spores from vegetative cells are well known in the field. In some examples, vegetative bacterial cells are grown in liquid medium. Beginning in the late logarithmic growth phase or early stationary growth phase, the bacteria may begin to sporulate. When the bacteria have finished sporulating, the spores may be obtained from the medium, by using centrifugation for example. Various methods may be used to kill or remove any remaining vegetative cells. Various methods may be used to purify the spores from cellular debris and/or other materials or substances. Bacterial spores may be differentiated from vegetative cells using a variety of techniques, like phase-contrast microscopy, automated scanning microscopy, high resolution atomic force microscopy or tolerance to heat, for example.

Because bacterial spores are generally environmentally-tolerant structures that are metabolically inert or dormant, they are readily chosen to be used in commercial microbial products. Despite their ruggedness and extreme longevity, spores can rapidly respond to the presence of small specific molecules known as germinants that signal favorable conditions for breaking dormancy through germination, an initial step in the process of completing the lifecycle by returning to vegetative bacteria. For example, the commercial microbial products may be designed to be dispersed into an environment where the spores encounter the germinants present in the environment to germinate into vegetative cells and perform an intended function. A variety of different bacteria may form spores. Bacteria from any of these groups may be used in the compositions, methods, and kits disclosed herein. For example, some bacteria of the following genera may form spores: Acetonema, Alkalibacillus, Ammoniphilus, Amphibacillus, Anaerobacter, Anaerospora, Aneurinibacillus, Anoxybacillus, Bacillus, Brevibacillus, Caldanaerobacter, Caloramator, Caminicella, Cerasibacillus, Clostridium, Clostridiisalibacter, Cohnella, Dendrosporobacter, Desulfotomaculum, Desulfosporomusa, Desulfosporosinus, Desulfovirgula, Desulfunispora, Desulfurispora, Filifactor, Filobacillus, Gelria, Geobacillus, Geosporobacter, Gracilibacillus, Halonatronum, Heliobacterium, Heliophilum, Laceyella, Lentibacillus, Lysinibacillus, Mahella, Metabacterium, Moorella, Natroniella, Oceanobacillus, Orenia, Ornithinibacillus, Oxalophagus, Oxobacter, Paenibacillus, Paraliobacillus, Pelospora, Pelotomaculum, Piscibacillus, Planifilum, Pontibacillus, Propionispora, Salinibacillus, Salsuginibacillus, Seinonella, Shimazuella, Sporacetigenium, Sporoanaerobacter, Sporobacter, Sporobacterium, Sporohalobacter, Sporolactobacillus, Sporomusa, Sporosarcina, Sporotalea, Sporotomaculum, Syntrophomonas, Syntrophospora, Tenuibacillus, Tepidibacter, Terribacillus, Thalassobacillus, Thermoacetogenium, Thermoactinomyces, Thermoalkalibacillus, Thermoanaerobacter, Thermoanaeromonas, Thermobacillus, Thermoflavimicrobium, Thermovenabulum, Tuberibacillus, Virgibacillus, and/or Vulcanobacillus.

Preferably, the bacteria that may form spores are from the family Bacillaceae, such as species of the genera Aeribacillus, Aliibacillus, Alkalibacillus, Alkalicoccus, Alkalihalobacillus, Alkalilactibacillus, Allobacillus, Alteribacillus, Alteribacter, Amphibacillus, Anaerobacillus, Anoxybacillus, Aquibacillus, Aquisalibacillus, Aureibacillus, Bacillus, Caldalkalibacillus, Caldibacillus, Calditerricola, Calidifontibacillus, Carnelliibacillus, Cerasibacillus, Compostibacillus, Cytobacillus, Desertibacillus, Domibacillus, Ectobacillus, Evansella, Falsibacillus, Ferdinandcohnia, Fermentibacillus, Fictibacillus, Filobacillus, Geobacillus, Geomicrobium, Gottfriedia, Gracilibacillus, Halalkalibacillus, Halobacillus, Halolactibacillus, Heyndrickxia, Hydrogenibacillus, Lederbergia, Lentibacillus, Litchfieldia, Lottiidibacillus, Margalitia, Marinococcus, Melghiribacillus, Mesobacillus, Metabacillus, Microaerobacter, Natribacillus, Natronobacillus, Neobacillus, Niallia, Oceanobacillus, Ornithinibacillus, Parageobacillus, Paraliobacillus, Paralkalibacillus, Paucisalibacillus, Pelagirhabdus, Peribacillus, Piscibacillus, Polygonibacillus, Pontibacillus, Pradoshia, Priestia, Pseudo gracilibacillus, Pueribacillus, Radiobacillus, Robertmurraya, Rossellomorea, Saccharococcus, Salibacterium, Salimicrobium, Salinibacillus, Salipaludibacillus, Salirhabdus, Salisediminibacterium, Saliterribacillus, Salsuginibacillus, Sediminibacillus, Siminovitchia, Sinibacillus, Sinobaca, Streptohalobacillus, Sutcliffiella, Swionibacillus, Tenuibacillus, Tepidibacillus, Terribacillus, Terrilactibacillus, Texcoconibacillus, Thalassobacillus, Thalassorhabdus, Thermolongibacillus, Virgibacillus, Viridibacillu, Vulcanibacillus, Weizmannia. In various examples, the bacteria may be strains of Bacillus Bacillus acidicola, Bacillus aeolius, Bacillus aerius, Bacillus aerophilus, Bacillus albus, Bacillus altitudinis, Bacillus alveayuensis, Bacillus amyloliquefaciensex, Bacillus anthracis, Bacillus aquiflavi, Bacillus atrophaeus, Bacillus australimaris, Bacillus badius, Bacillus benzoevorans, Bacillus cabrialesii, Bacillus canaveralius, Bacillus capparidis, Bacillus carboniphilus, Bacillus cereus, Bacillus chungangensis, Bacillus coahuilensis, Bacillus cytotoxicus, Bacillus decisifrondis, Bacillus ectoiniformans, Bacillus enclensis, Bacillus fengqiuensis, Bacillus fungorum, Bacillus glycinifermentans, Bacillus gobiensis, Bacillus halotolerans, Bacillus haynesii, Bacillus horti, Bacillus inaquosorum, Bacillus infantis, Bacillus infernus, Bacillus isabeliae, Bacillus kexueae, Bacillus licheniformis, Bacillus luti, Bacillus manusensis, Bacillus marinisedimentorum, Bacillus mesophilus, Bacillus methanolicus, Bacillus mobilis, Bacillus mojavensis, Bacillus mycoides, Bacillus nakamurai, Bacillus ndiopicus, Bacillus nitratireducens, Bacillus oleivorans, Bacillus pacificus, Bacillus pakistanensis, Bacillus paralicheniformis, Bacillus paramycoides, Bacillus paranthracis, Bacillus pervagus, Bacillus piscicola, Bacillus proteolyticus, Bacillus pseudomycoides, Bacillus pumilus, Bacillus safensis, Bacillus salacetis, Bacillus salinus, Bacillus salitolerans, Bacillus seohaeanensis, Bacillus shivajii, Bacillus siamensis, Bacillus smithii, Bacillus solimangrovi, Bacillus songklensis, Bacillus sonorensis, Bacillus spizizenii, Bacillus spongiae, Bacillus stercoris, Bacillus stratosphericus, Bacillus subtilis, Bacillus swezeyi, Bacillus taeanensis, Bacillus tamaricis, Bacillus tequilensis, Bacillus thermocloacae, Bacillus thermotolerans, Bacillus thuringiensis, Bacillus tianshenii, Bacillus toyonensis, Bacillus tropicus, Bacillus vallismortis, Bacillus velezensis, Bacillus wiedmannii, Bacillus wudalianchiensis, Bacillus xiamenensis, Bacillus xiapuensis, Bacillus zhangzhouensis, or combinations thereof.

In some examples, the bacterial strains that form spores may be strains of Bacillus, including: Bacillus sp. strain SD-6991; Bacillus sp. strain SD-6992; Bacillus sp. strain NRRL B-50606; Bacillus sp. strain NRRL B-50887; Bacillus pumilus strain NRRL B-50016; Bacillus amyloliquefaciens strain NRRL B-50017; Bacillus amyloliquefaciens strain PTA-7792 (previously classified as Bacillus atrophaeus); Bacillus amyloliquefaciens strain PTA-7543 (previously classified as Bacillus atrophaeus); Bacillus amyloliquefaciens strain NRRL B-50018; Bacillus amyloliquefaciens strain PTA-7541; Bacillus amyloliquefaciens strain PTA-7544; Bacillus amyloliquefaciens strain PTA-7545; Bacillus amyloliquefaciens strain PTA-7546; Bacillus subtilis strain PTA-7547; Bacillus amyloliquefaciens strain PTA-7549; Bacillus amyloliquefaciens strain PTA-7793; Bacillus amyloliquefaciens strain PTA-7790; Bacillus amyloliquefaciens strain PTA-7791; Bacillus subtilis strain NRRL B-50136 (also known as DA-33R, ATCC accession No. 55406); Bacillus amyloliquefaciens strain NRRL B-50141; Bacillus amyloliquefaciens strain NRRL B-50399; Bacillus licheniformis strain NRRL B-50014; Bacillus licheniformis strain NRRL B-50015; Bacillus amyloliquefaciens strain NRRL B-50607; Bacillus subtilisstrain NRRL B-50147 (also known as 300R); Bacillus amyloliquefaciens strain NRRL B-50150; Bacillus amyloliquefaciens strain NRRL B-50154; Bacillus megaterium PTA-3142; Bacillus amyloliquefaciens strain ATCC accession No. 55405 (also known as 300); Bacillus amyloliquefaciens strain ATCC accession No. 55407 (also known as PMX); Bacillus pumilus NRRL B-50398 (also known as ATCC 700385, PMX-1, and NRRL B-50255); Bacillus cereus ATCC accession No. 700386; Bacillus thuringiensis ATCC accession No. 700387 (all of the above strains are available from Novozymes, Inc., USA); Bacillus amyloliquefaciens FZB24 (e.g., isolates NRRL B-50304 and NRRL B-50349 TAEGRO® from Novozymes), Bacillus pumilus (e.g., isolate NRRL B-50349 from Bayer CropScience), Bacillus amyloliquefaciens TrigoCor (also known as “TrigoCor 1448”; e.g., isolate Embrapa Trigo Accession No. 144/88.4Lev, Cornell Accession No.Pma007BR-97, and ATCC accession No. 202152, from Cornell University, USA) and combinations thereof.

In some examples, the bacterial strains that form spores may be strains of Bacillus amyloliquefaciens. For example, the strains may be Bacillus amyloliquefaciens strain PTA-7543 (previously classified as Bacillus atrophaeus), and/or Bacillus amyloliquefaciens strain NRRL B-50154, Bacillus amyloliquefaciens strain PTA-7543 (previously classified as Bacillus atrophaeus), Bacillus amyloliquefaciens strain NRRL B-50154, or from other Bacillus amyloliquefaciens organisms.

In some examples, the bacterial strains that form spores may be Brevibacillus spp., e.g., Brevibacillus brevis; Brevibacillus formosus; Brevibacillus laterosporus; or Brevibacillus parabrevis, or combinations thereof.

In some examples, the bacterial strains that form spores may be Paenibacillus spp., e.g., Paenibacillus alvei; Paenibacillus amylolyticus; Paenibacillus azotofixans; Paenibacillus cookii; Paenibacillus macerans; Paenibacillus polymyxa; Paenibacillus validus, or combinations thereof.

The bacterial spores may have an average particle diameter of about 2-50 microns, preferably about 10-45 microns. Bacillus spores are commercially available in blends in aqueous carriers and are insoluble in the aqueous carriers. Other commercially available bacillus spore blends include without limitation Freshen Free™ CAN (10X), available from Novozymes Biologicals, Inc.; Evogen® Renew Plus (10X), available from Genesis Biosciences, Inc.; and Evogen® GT (10X, 20X and 110X), all available from Genesis Biosciences, Inc. In the foregoing list, the parenthetical notations (10X, 20X, and 110X) indicate relative concentrations of the Bacillus spores.

Bacterial spores used in the compositions, methods, and products disclosed herein may or may not be heat activated. In some examples, the bacterial spores are heat activated. In some examples, the bacterial spores are not heat inactivated. Preferably, the spores used herein are heat activated. Heat activation may comprise heating bacterial spores from room temperature (15-25° C.) to optimal temperature of between 25-120° C., preferably between 40 C-100° C., and held at the optimal temperature for not more than 2 hours, preferably between 70-80° C. for 30 min.

For the methods and compositions disclosed herein, populations of bacterial spores are generally used. In some examples, a population of bacterial spores may include bacterial spores from a single strain of bacterium. Preferably, a population of bacterial spores may include bacterial spores from 2, 3, 4, 5, or more strains of bacteria. Generally, a population of bacterial spores contains a majority of spores and a minority of vegetative cells. In some examples, a population of bacterial spores does not contain vegetative cells. In some examples, a population of bacterial spores may contain less than about 1%, 2%, 3%, 4%, 5%, 6%, 7%, 8%, 9%, 10%, 15%, 20%, 25%, 30%, 40%, or 50% vegetative cells, where the percentage of bacterial spores is calculated as ((vegetative cells/(spores in population+vegetative cells in population))×100). Generally, populations of bacterial spores used in the disclosed methods, compositions and products are stable (i.e. not undergoing germination), with at least some individual spores in the population capable of germinating.

Suitable cleaning ingredients include at least one of a surfactant, an enzyme, an enzyme stabilizing system, a detergent builder, a chelating agent, a complexing agent, clay soil removal/anti-redeposition agents, polymeric soil release agents, polymeric dispersing agents, polymeric grease cleaning agents, a dye transfer inhibiting agent, a bleaching agent, a bleach activator, a bleaching catalyst, a fabric conditioner, a clay, a foam booster, an anti-foam, a suds suppressor, an anti-corrosion agent, a soil-suspending agent, a dye, a hueing dye, a bactericide, a tarnish inhibitor, an optical brightener, a perfume, a saturated or unsaturated fatty acid, a calcium cation, a magnesium cation, a visual signaling ingredient, a structurant, a thickener, a starch, sand, a gelling agents, or any combination thereof.

Surfactant

A composition as described herein can comprise from 10 to 85% by weight of surfactants, preferably from 15 to 60%, more preferably from 20 to 50%, most preferably from 20 to 35%, based on total weight of the concentrated laundry composition. Suitable surfactants comprise anionic surfactants, non-ionic surfactants or mixtures thereof. Preferably, the composition of the invention comprises and anionic surfactant and a non-ionic surfactant.

Anionic Surfactant. Non-limiting examples of suitable anionic surfactants include any conventional anionic surfactant, such as linear alkylbenzenesulfonate (LAS), alpha-olefinsulfonate (AOS), alkyl sulfate (fatty alcohol sulfate) (AS), alcohol ethoxysulfate (AEOS or AES), secondary alkanesulfonates (SAS), alpha-sulfo fatty acid methyl esters, alkyl- or alkenylsuccinic acid, or soap.

Nonionic surfactant. Suitable nonionic surfactants useful herein can comprise any conventional nonionic surfactant. Other non-limiting examples of nonionic surfactants useful herein include: C₅-C₁₈ alkyl ethoxylates, such as, NEODOL® nonionic surfactants from Shell; C₆-C₁₂ alkyl phenol alkoxylates wherein the alkoxylate units may be ethyleneoxy units, propyleneoxy units, or a mixture thereof; C₁₂-C₁₈ alcohol and C₆-C₁₂ alkyl phenol condensates with ethylene oxide/propylene oxide block polymers such as Pluronic® from BASF; C₁₄-C₂₂ mid-chain branched alcohols (BA); C₁₄-C₂₂ mid-chain branched MEA (BAEₓ), wherein x is from 1 to 30; polyhydroxy fatty acid amides; and ether capped poly(oxyalkylated) alcohol surfactants. Suitable nonionic detersive surfactants also include alkyl alkoxylated alcohol. Suitable nonionic surfactants also include those sold under the tradename Lutensol® from BASF.

Preferably, the non-ionic surfactant comprises alkyl alcohol ethoxylates, fatty acid alkanolamides, alkoxylated glycerol esters or mixtures thereof.

Preferably, the selection and amount of surfactant is such that the concentrated laundry composition and the diluted composition are isotropic in nature.

Rheology Modifier

The composition of the invention comprises a rheology modifier. Preferably the rheology modifier is a polymer. Preferably the composition of the invention comprises from 5 to 20% by weight of the composition of the rheology modifier, preferably from 5 to 10% by weight of the composition of the rheology modifier. Most preferably, the composition of the invention comprises from 5 to 10% by weight of the composition of a grafted copolymer.

The preferred rheology-modifying polymer for use herein is a grafted copolymer, preferably a grafted copolymer of an acrylic polymer and fatty alcohol alkoxylates. Preferably, the acrylic polymer is a homopolymer of acrylic acid. In another preferred embodiment, the acrylic polymer is a copolymer of C10-C30 alkyl acrylate and one or more monomers of acrylic acid, methacrylic acid, or one of their short chain (C1-C4 alcohol) esters.

The grafted copolymer can be obtained by grafting the fatty alcohol alkoxylate onto the acrylic polymer backbones. The fatty alcohol alkoxylate is represented by the below formula:

R₁₀O—(CH2CH2O)a—(CHCH3CH2O)b—(CH2CH₂O)c—H
wherein R10 is a linear or branched, alkyl or alkenyl group having from 10 to 22 carbon atoms, preferably from 12 to 18 carbon atoms; each of a and c is a number of from 0 to 30, preferably from 1 to 15 and more preferably from 1 to 10, b is a number of from 0 to 10, preferably from 0 to 5, more preferably from 0 to 2. The sum of a and c being in the range of from 1 to 30, preferably from 1 to 20, more preferably from 1 to 10.

Preferably, the grafted copolymer is a copolymer of an acrylic polymer and fatty alcohol ethoxylates, which is represented by the formula:

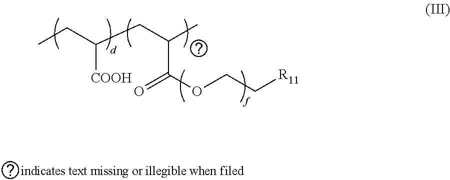

where d is a number of from 1 to 150; e is a number of from 2 to 500, more preferable from 2 to 250; R11 is a linear or branched, alkyl or alkenyl group having from 10 to 22 carbon atoms, preferably from 12 to 18 carbon atoms; f is a number of from 1 to 30, preferably from 1 to 20, more preferably from 1 to 10.

Suitable physiologically acceptable salts of the grafted copolymer include its sodium, magnesium, potassium, ammonium and -mono-, di-, and triethanolamine salts. It should be noted that where the grafted copolymer is mentioned in the present disclosure, this also includes the corresponding physiologically acceptable salts thereof, also where not explicitly stated.

The grafted copolymer preferably has a molecular weight of from 1000 to 300,000 g/mol, more preferably from 10000 to 100,000 g/mol. Suitable grafted copolymer for use in the present invention can be prepared by known methods, such as the method disclosed in CN 105154245 A, which is incorporated herein by reference in its entirety.

The concentrated laundry composition of the present invention comprises the grafted copolymer in an amount of from 5 to 9.5% by weight of the composition, preferably from 5.5 to 9.2%, more preferably from 6 to 9%, and most preferably from 6.5 to 9%, based on total weight of the concentrated laundry composition and including all ranges subsumed therein.

The pH of the composition is strictly controlled such that the p11 does not change during dilution by the consumer and also provides appropriate phase control during dilution. The pH of the concentrated laundry composition is from 5 to 9 and preferably from 6.0 to 8.5.

The concentrated laundry composition of the present invention may further comprise another rheology-modifying polymer in addition to the grafted copolymer which is already included in the composition.

Preferred rheology-modifying polymer comprises an ethoxylated sorbitan ester viscosity modifier. The ethoxylated sorbitan ester provides improved rheological characteristics in the context of a product which is diluted by the consumer in the domestic environment. It should be noted that this is independent of any rheological behavior which is affected by pouring or otherwise using the diluted product. The concentrated laundry composition is to be diluted by the user and as such it is necessary for the concentrated laundry composition to behave rheologically appropriately.

More preferably the ethoxylated sorbitan ester comprises from 50 to 1000 ethoxylate units, more preferably from 200 to 700 and most preferably from 300 to 550.

Preferably, the ethoxylated sorbitan ester comprises one to five, more preferably three to five fatty acid esters. More preferably, the ethoxylated sorbitan ester comprises a fatty acid having from 10 to 22 carbons, more preferably from 14 to 20 and most preferably 18 carbons. The fatty acid may be straight chain car branched, saturated or unsaturated. The most preferred fatty acid group is a stearic acid group.

The most preferred ethoxylated sorbitan ester is sorbeth-450 tristearate and which is the triester of stearic acid and a polyethylene glycol ether of sorbitol with an average of 450 moles of ethylene oxide.

Preferably the ethoxylated sorbitan ester is present at 0.01 to 8.0% by weight of the concentrated laundry composition.

Preferably, the composition comprises PEG ester fatty acid. PEG fatty acid ester is included to modify the rheological performance of the composition particularly during dilution. Preferred PEG ester fatty acids include PEG 9 cocoate, PEG 32 and PEG 1.75.

Preferably, the PEG ester fatty acid is present at from 0.01 to 5.0% by weight of the concentrated laundry composition.

A further rheology modifier suitable for use in the present invention is hydrogenated castor oil, for example Thixin® R sold by Elementis, East Windsor, NJ, USA.

Rheology modifiers suitable for use in the present invention are also disclosed in WO 2017/075681.

Enzymes. Preferably the composition comprises one or more enzymes. Preferred enzymes provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, mannanases, galactanases, pectate lyases, keratinases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof. Preferably, when the composition of the invention is a laundry composition, it comprises an amylase and a protease and optionally a lipase. Preferably, the compositions of the invention are free of glucanases.

Proteases. Preferably the composition comprises one or more proteases. Suitable proteases include metalloproteases and serine proteases, including neutral or alkaline microbial serine proteases, such as subtilisins (EC 3.4.21.62). Suitable proteases include those of animal, vegetable or microbial origin. In one aspect, such suitable protease may be of microbial origin. The suitable proteases include chemically or genetically modified mutants of the aforementioned suitable proteases. In one aspect, the suitable protease may be a serine protease, such as an alkaline microbial protease or/and a trypsin-type protease. Examples of suitable neutral or alkaline proteases include:
(a) subtilisins (EC 3.4.21.62), especially those derived from Bacillus, such as Bacillus sp., B. lentus, B. alkalophilus, B. subtilis, B. amyloliquefaciens, B. pumilus, B. gibsonii, and B. akibaii described in WO2004067737, WO2015091989, WO2015091990, WO2015024739, WO2015143360, U.S. Pat. No. 6,312,936 B1, U.S. Pat. Nos. 5,679,630, 4,760,025, DE102006022216A1, DE102006022224A1, WO2015089447, WO2015089441, WO2016066756, WO2016066757, WO2016069557, WO2016069563, WO2016069569.
(b) trypsin-type or chymotrypsin-type proteases, such as trypsin (e.g., of porcine or bovine origin), including the Fusarium protease described in WO 89/06270 and the chymotrypsin proteases derived from Cellumonas described in WO 05/052161 and WO 05/052146.
(c) metalloproteases, especially those derived from Bacillus amyloliquefaciens described in WO07/044993A2; from Bacillus, Brevibacillus, Thermoactinomyces, Geobacillus, Paenibacillus, Lysinibacillus or Streptomyces spp. Described in WO2014194032, WO2014194054 and WO2014194117; from Kribella alluminosa described in WO2015193488; and from Streptomyces and Lysobacter described in WO2016075078.
(d) Protease having at least 90% identity to the subtilase from Bacillus sp. TY145, NCIMB 40339, described in WO92/17577 (Novozymes A/S), including the variants of this Bacillus sp TY145 subtilase described in WO2015024739, and WO2016066757.

Suitable commercially available protease enzymes include those sold under the trade names Alcalase®, Savinase®, Primase®, Durazym®, Polarzyme®, Kannase®, Liquanase®, Liquanase Ultra®, Savinase Ultra®, Ovozyme®, Neutrase®, Everlase® and Esperase® by Novozymes A/S (Denmark); those sold under the tradename Maxatase®, Maxacal®, Maxapem®, Properase®, Purafect®, Purafect Prime®, Purafect Ox®, FN3®, FN4®, Excellase® and Purafect OXP® by Dupont; those sold under the tradename Opticlean® and Optimase® by Solvay Enzymes; and those available from Henkel/Kemira, namely BLAP (sequence shown in FIG. 29 of U.S. Pat. No. 5,352,604), and KAP (Bacillus alkalophilus subtilisin with mutations A230V+S256G+S259N) from Kao.

Amylases. Preferably the composition may comprise an amylase. Suitable alpha-amylases include those of bacterial or fungal origin. Chemically or genetically modified mutants (variants) are included. A preferred alkaline alpha-amylase is derived from a strain of Bacillus, such as Bacillus licheniformis, Bacillus amyloliquefaciens, Bacillus stearothermophilus, Bacillus subtilis, or other Bacillus sp., such as Bacillus sp. NCIB 12289, NCIB 12512, NCIB 12513, DSM 9375 (U.S. Pat. No. 7,153,818) DSM 12368, DSMZ no. 12649, KSM AP1378 (WO 97/00324), KSM K36 or KSM K38 (EP 1,022,334). Preferred amylases include:
(a) variants described in WO 94/02597, WO 94/18314, WO96/23874 and WO 97/43424,
(b) variants described in U.S. Pat. No. 5,856,164 and WO99/23211, WO 96/23873, WO00/60060 and WO 06/002643,
(c) variants in WO06/002643, of the wild-type enzyme from Bacillus SP722, especially variants described in WO 00/60060, which is incorporated herein by reference.
(d) variants exhibiting at least 95% identity with the wild-type enzyme from Bacillus sp.707 in U.S. Pat. No. 6,093,562, especially those comprising one or more of the following mutations M202, M208, 5255, R172, and/or M261. Preferably said amylase comprises one or more of M202L, M202V, M202S, M202T, M2021, M202Q, M202W, S255N and/or R172Q. Particularly preferred are those comprising the M202L or M202T mutations.
(e) variants described in WO 09/149130,
(f) variants in WO2016091688.
(g) variants of the “PcuAmyl α-amylase” from Paenibacillus curdlanolyticus YK9 (in WO2014099523).
(h) variants of the “CspAmy2 amylase” from Cytophaga sp. (in WO2014164777).
(i) variants in WO2009149271.
(j) Variants exhibiting at least 90% identity variant with the wild-type amylase from Bacillus sp. KSM-K38 with accession number AB051102.

Suitable commercially available alpha-amylases include DURAMYL®, LIQUEZYME®, TERMAMYL®, TERMAMYL ULTRA®, NATALASE®, SUPRAMYL®, STAINZYME®, STAINZYME PLUS®, FUNGAMYL® and BAN® (Novozymes A/S, Bagsvaerd, Denmark), KEMZYM® AT 9000 Biozym Biotech Trading GmbH Wehlistrasse 27b A-1200 Wien Austria, RAPIDASE®, PURASTAR®, ENZYSIZE®, OPTISIZE HT PLUS®, POWERASE® and PURASTAR OXAM® (Genencor International Inc., Palo Alto, California) and KAM® (Kao, 14-10 Nihonbashi Kayabacho, 1-chome, Chuo-ku Tokyo 103-8210, Japan). In one aspect, suitable amylases include NATALASE®, STAINZYME® and STAINZYME PLUS® and mixtures thereof.

Lipases. Preferably the composition comprises one or more lipases, including “first cycle lipases” such as those described in U.S. Pat. No. 6,939,702 B1 and US PA 2009/0217464. Preferred lipases are first-wash lipases. The composition may comprise a first wash lipase.

Enzyme Stabilizing System. The composition may optionally comprise from about 0.001% to about 10% by weight of the composition, of an enzyme stabilizing system. The enzyme stabilizing system can be any stabilizing system which is compatible with the detersive enzyme. In the case of aqueous detergent compositions comprising protease, a reversible protease inhibitor, such as a boron compound, including borate, 4-formyl phenylboronic acid, phenylboronic acid and derivatives thereof, or compounds such as calcium formate, sodium formate and 1,2-propane diol may be added to further improve stability.

Builder. The composition may optionally comprise a builder or a builder system. Built cleaning compositions typically comprise at least about 1% builder, based on the total weight of the composition. Liquid cleaning compositions may comprise up to about 10% builder, and in some examples up to about 8% builder, of the total weight of the composition. Granular cleaning compositions may comprise up to about 30% builder, and in some examples up to about 5% builder, by weight of the composition.

Builders selected from aluminosilicates (e.g., zeolite builders, such as zeolite A, zeolite P, and zeolite MAP) and silicates assist in controlling mineral hardness in wash water, especially calcium and/or magnesium, or to assist in the removal of particulate soils from surfaces. Suitable builders may be selected from the group consisting of phosphates, such as polyphosphates (e.g., sodium tri-polyphosphate), especially sodium salts thereof; carbonates, bicarbonates, sesquicarbonates, and carbonate minerals other than sodium carbonate or sesquicarbonate; organic mono-, di-, tri-, and tetracarboxylates, especially water-soluble nonsurfactant carboxylates in acid, sodium, potassium or alkanolammonium salt form, as well as oligomeric or water-soluble low molecular weight polymer carboxylates including aliphatic and aromatic types; and phytic acid. These may be complemented by borates, e.g., for pH-buffering purposes, or by sulfates, especially sodium sulfate and any other fillers or carriers which may be important to the engineering of stable surfactant and/or builder-containing cleaning compositions. Additional suitable builders may be selected from citric acid, lactic acid, fatty acid, polycarboxylate builders, for example, copolymers of acrylic acid, copolymers of acrylic acid and maleic acid, and copolymers of acrylic acid and/or maleic acid, and other suitable ethylenic monomers with various types of additional functionalities. Also suitable for use as builders herein are synthesized crystalline ion exchange materials or hydrates thereof having chain structure and a composition represented by the following general anhydride form: x(M₂O)·ySiO₂·zM′O wherein M is Na and/or K, M′ is Ca and/or Mg; y/x is 0.5 to 2.0; and z/x is 0.005 to 1.0.

Alternatively, the composition may be substantially free of builder.

Chelating Agent. The composition may also comprise one or more metal ion chelating agents. Suitable molecules include copper, iron and/or manganese chelating agents and mixtures thereof. Such chelating agents can be selected from the group consisting of phosphonates, amino carboxylates, amino phosphonates, succinates, polyfunctionally-substituted aromatic chelating agents, 2-pyridinol-N-oxide compounds, hydroxamic acids, carboxymethyl inulins, and mixtures therein. Chelating agents can be present in the acid or salt form including alkali metal, ammonium, and substituted ammonium salts thereof, and mixtures thereof.

Additional Amines: Additional amines may be used in the composition for added removal of grease and particulates from soiled materials. The compositions may comprise from about 0.1% to about 10%, in some examples, from about 0.1% to about 4%, and in other examples, from about 0.1% to about 2%, by weight of the cleaning composition, of additional amines. Non-limiting examples of additional amines may include, but are not limited to, polyamines, oligoamines, triamines, diamines, pentamines, tetraamines, or combinations thereof. Specific examples of suitable additional amines include tetraethylenepentamine, triethylenetetraamine, diethylenetriamine, or a mixture thereof.

Dye Transfer Inhibiting Agent. The composition can further comprise one or more dye transfer inhibiting agents. Suitable dye transfer inhibiting agents include, for example, polyvinylpyrrolidone polymers, polyamine N-oxide polymers, copolymers of N-vinylpyrrolidone and N-vinylimidazole, polyvinyloxazolidones, polyvinylimidazoles, manganese phthalocyanine, peroxidases, polyvinylpyrrolidone polymers, ethylene-diamine-tetraacetic acid (EDTA); diethylene triamine penta methylene phosphonic acid (DTPMP); hydroxy-ethane diphosphonic acid (HEDP); ethylenediamine N,N′-disuccinic acid (EDDS); methyl glycine diacetic acid (MGDA); diethylene triamine penta acetic acid (DTPA); propylene diamine tetraacetic acid (PDT A); 2-hydroxypyridine-N-oxide (HPNO); or methyl glycine diacetic acid (MGDA); glutamic acid N,N-diacetic acid (N,N-dicarboxymethyl glutamic acid tetrasodium salt (GLDA); nitrilotriacetic acid (NTA); 4,5-dihydroxy-m-benzenedisulfonic acid; citric acid and any salts thereof; N-hydroxyethylethylenediaminetri-acetic acid (HEDTA), triethylenetetraaminehexaacetic acid (TTHA), N-hydroxyethyliminodiacetic acid (HEIDA), dihydroxyethylglycine (DHEG), ethylenediaminetetrapropionic acid (EDTP) and derivatives thereof or a combination thereof.

Bleaching Compounds, Bleaching Agents, Bleach Activators, and Bleach Catalysts. The compositions described herein may comprise bleaching agents, bleach activators and/or bleach catalysts. Bleaching ingredients may be present at levels of from about 1% to about 30%, and in some examples from about 5% to about 20%, based on the total weight of the composition. If present, the amount of bleach activator may be from about 0.1% to about 60%, and in some examples from about 0.5% to about 40%, of the composition. When the composition is a laundry composition in powder form, the composition preferably comprises percarbonate bleach, and a bleach activator, preferably TAED. If the composition is a laundry composition in liquid form, it is preferred that the liquid composition is substantially free of bleaching compounds.

Examples of bleaching agents include oxygen bleach, perborate bleach, percarboxylic acid bleach and salts thereof, peroxygen bleach, persulfate bleach, percarbonate bleach, and mixtures thereof.

In some examples, compositions may also include a transition metal bleach catalyst.

Bleaching agents other than oxygen bleaching agents are also known in the art and can be utilized in composition. They include, for example, photoactivated bleaching agents, or pre-formed organic peracids, such as peroxycarboxylic acid or salt thereof, or a peroxysulphonic acid or salt thereof.

Brightener. Optical brighteners or other brightening or whitening agents may be incorporated at levels of from about 0.01% to about 1.2%, by weight of the composition. Commercial brighteners, which may be used herein, can be classified into subgroups, which include, but are not necessarily limited to, derivatives of stilbene, pyrazoline, coumarin, benzoxazoles, carboxylic acid, methinecyanines, dibenzothiophene-5,5-dioxide, azoles, 5- and 6-membered-ring heterocycles, and other miscellaneous agents.

In some examples, the fluorescent brightener is selected from the group consisting of disodium 4,4′-bis{[4-anilino-6-morpholino-s-triazin-2-yl]-amino}-2,2′-stilbenedisulfonate (brightener 15, commercially available under the tradename Tinopal AMS-GX by Ciba Geigy Corporation), disodium4,4′-bis{[4-anilino-6-(N-2-bis-hydroxyethyl)-s-triazine-2-yl]-amino}-2,2′-stilbenedisulonate (commercially available under the tradename Tinopal UNPA-GX by Ciba-Geigy Corporation), disodium 4,4′-bis{[4-anilino-6-(N-2-hydroxyethyl-N-methylamino)-s-triazine-2-yl]-amino}-2,2′-stilbenedisulfonate (commercially available under the tradename Tinopal 5BM-GX by Ciba-Geigy Corporation). More preferably, the fluorescent brightener is disodium 4,4′-bis{[4-anilino-6-morpholino-s-triazin-2-yl]-amino}-2,2′-stilbenedisulfonate.

The brighteners may be added in particulate form or as a premix with a suitable solvent, for example nonionic surfactant, monoethanolamine, propane diol.

Fabric Hueing Agent. The composition may comprise a fabric hueing agent (sometimes referred to as shading, bluing or whitening agents). Typically, the hueing agent provides a blue or violet shade to fabric. Hueing agents can be used either alone or in combination to create a specific shade of hueing and/or to shade different fabric types. This may be provided for example by mixing a red and green-blue dye to yield a blue or violet shade. Hueing agents may be selected from any known chemical class of dye, including but not limited to acridine, anthraquinone (including polycyclic quinones), azine, azo (e.g., monoazo, disazo, trisazo, tetrakisazo, polyazo), including premetallized azo, benzodifurane and benzodifuranone, carotenoid, coumarin, cyanine, diazahemicyanine, diphenylmethane, formazan, hemicyanine, indigoids, methane, naphthalimides, naphthoquinone, nitro and nitroso, oxazine, phthalocyanine, pyrazoles, stilbene, styryl, triarylmethane, triphenylmethane, xanthenes and mixtures thereof.

### Pro-Perfume Materials

The composition of the present disclosure may comprises pro-perfume materials. Sometimes referred to as pro-fragrances or fragrance precursors. Pro-perfume materials typically comprise a covalent bond between a carrier and one or more perfume raw material(s) (PRM(s)). Once the spores germinate, the one or more PRMs are then released upon exposure to enzymes excreted by the bacteria. Pro-perfume materials can provide extended PRMs release profiles, resulting in long-lasting freshness benefits. Furthermore, because the total amount of PRMs is not released or otherwise available at one time, the olfactory impact of the PRMs is moderated. In compositions of the present invention, such release profiles can mitigate what might otherwise be experienced as an overpowering smell, due to the relatively high levels of fragrance.

The pro-perfume material of the composition of the present invention comprises PRM. The pro-perfume material is capable of releasing the PRM when exposed to the enzymes released by the bacteria.

The pro-perfume material may gradually release the PRM when the spores germinate and the bacteria contained in the spore excrete enzymes. The gemination of the spores is not triggered during product storage but only during and after the product is used. Good conditions for spore germination are for example found during the wearing of treated fabrics, in particular when the body of the user is sweating.

Pro-perfume materials for use herein can be selected from the group consisting of glycosides, phosphate acid esters, amino-acid derivatives and carboxylic acid derivatives and mixtures thereof. Especially preferred pro-perfumes to use in the composition and method of the invention comprise glycosides pro-perfumes.

The composition of the invention preferably may comprises from about 0.01% to about 10%, preferably from about 0.05% to about 5% by weight of the composition of pro-perfumes.

### Perfume

The composition of the invention may comprise a perfume, preferably from about 0.001% to about 10%, more preferably from about 0.001 to about 5% by weight of the composition of perfume.

Said perfume may comprise perfume raw materials selected from the group consisting of alcohols, ketones, aldehydes, esters, ethers, nitriles alkenes and mixtures thereof. The perfume may comprise a perfume raw material selected from the group consisting of perfume raw materials having a boiling point (B.P.) lower than about 250° C. and a ClogP lower than about 3, perfume raw materials having a B.P. of greater than about 250° C. and a ClogP of greater than about 3, perfume raw materials having a B.P. of greater than about 250° C. and a ClogP lower than about 3, perfume raw materials having a B.P. lower than about 250° C. and a ClogP greater than about 3 and mixtures thereof. Perfume raw materials having a boiling point B.P. lower than about 250° C. and a ClogP lower than about 3 are known as Quadrant I perfume raw materials, perfume raw materials having a B.P. of greater than about 250° C. and a ClogP of greater than about 3 are known as Quadrant IV perfume raw materials, perfume raw materials having a B.P. of greater than about 250° C. and a ClogP lower than about 3 are known as Quadrant II perfume raw materials, perfume raw materials having a B.P. lower than about 250° C. and a ClogP greater than about 3 are known as a Quadrant III perfume raw materials. In one aspect, said perfume comprises a perfume raw material having B.P. of lower than about 250° C. In one aspect, said perfume comprises a perfume raw material selected from the group consisting of Quadrant I, II, III perfume raw materials and mixtures thereof. In one aspect, said perfume comprises a Quadrant III perfume raw material. Suitable Quadrant I, II, III and IV perfume raw materials are disclosed in U.S. Pat. No. 6,869,923 B 1.

In one aspect, said perfume comprises a Quadrant IV perfume raw material. While not being bound by theory, it is believed that such Quadrant IV perfume raw materials can improve perfume odor “balance”. Said perfume may comprise, based on total perfume weight, less than about 30%, less than about 20%, or even less than about 15% of said Quadrant IV perfume raw material.

The perfume raw materials and accords may be obtained from one or more of the following companies Firmenich (Geneva, Switzerland), Givaudan (Argenteuil, France), IFF (Hazlet, NJ), Quest (Mount Olive, NJ), Bedoukian (Danbury, CT), Sigma Aldrich (St. Louis, MO), Millennium Specialty Chemicals (Olympia Fields, IL), Polarone International (Jersey City, NJ), Fragrance Resources (Keyport, NJ), and Aroma & Flavor Specialties (Danbury, CT).

Encapsulate. The composition may comprise an encapsulate. The encapsulate may comprises a core, a shell having an inner and outer surface, where the shell encapsulates the core.

Other ingredients. The composition can further comprise silicates. Suitable silicates can include, for example, sodium silicates, sodium disilicate, sodium metasilicate, crystalline phyllosilicates or a combination thereof. In some embodiments, silicates can be present at a level of from about 1% to about 20% by weight, based on the total weight of the composition.

The composition can further comprise other conventional detergent ingredients such as foam boosters, suds suppressors, anti-corrosion agents, soil-suspending agents, anti-soil redeposition agents, dyes, bactericides, tarnish inhibiters, and/or optical brighteners.

The composition can optionally further include saturated or unsaturated fatty acids, preferably saturated or unsaturated C₁₂-C₂₄ fatty acids; deposition aids, for example, polysaccharides, cellulosic polymers, poly diallyl dimethyl ammonium halides (DADMAC), and co-polymers of DADMAC with vinyl pyrrolidone, acrylamides, imidazoles, imidazolinium halides, and mixtures thereof, in random or block configuration, cationic guar gum, cationic cellulose, cationic starch, cationic polyacylamides or a combination thereof. If present, the fatty acids and/or the deposition aids can each be present at 0.1% to 10% by weight, based on the total weight of the composition.

The composition may optionally include silicone or fatty-acid based suds suppressors; hueing dyes, calcium and magnesium cations, visual signaling ingredients, anti-foam (0.001% to about 4.0% by weight, based on the total weight of the composition).

### Method of Doing Laundry

A method may include contacting a fabric with a detergent obtained by diluting a concentrated composition as described herein. A concentrated laundry composition can be diluted in water by a factor of 1 to 100 (i.e., 1 part of concentrate to 10 parts of water, by weight), preferably a factor of 8 to 12, a dilution of 1:10 is specially preferred to form the detergent. The detergent is subsequently dosed into the washing machine or use in a hand washing basin. The concentrate can be placed in a water-soluble pouch or it may be place in a suitable receptacle, such as a bottle and it can be added to another receptacle and then add water to make the detergent composition.

A method of the present disclosure may include contacting a fabric with an aqueous treatment liquor. The aqueous treatment liquor may comprise from about 1×10² Colony forming units (CFUs) to about 1×10⁸ CFU/liter of wash liquor, preferably from about 1×10⁴ CFUs to about 1×10⁷ CFU/liter of wash liquor of total bacterial spores, preferably Bacillus spores.

A method of treating a fabric may take place in any suitable vessel, in its entirety or partially, for example it may take place in an automatic washing machine. Such machines may be top-loading machines or front-loading machines. The process of the invention is also suitable for hand washing applications.

The treatment step may be part of a wash cycle of an automatic washing machine. A detergent obtained by diluting the concentrated composition of the present invention may be added to the drawer or drum of an automatic washing machine during a wash cycle.

The fabric treated may be a natural or a synthetic fabric. Suitable synthetic fabrics include polyester, acrylic, nylon, rayon, acetate, spandex, latex, and/or orlon fabrics. The composition and method of the invention provides very good malodor removal and/or prevention on synthetic fabric.

The fabric treated may include synthetic fibers. Suitable synthetic fibers may include polyester, acrylic, nylon, rayon, acetate, spandex, latex, and/or orlon fibers. The fibers may be elastic and/or contain elastane. The fabric may contain blends of synthetic fibers and natural fibers (e.g., a polycotton blend). The fabric may comprise fibers that are relatively hydrophobic (for example, compared to cotton fibers).

### Examples

The Table below illustrates compositions according to the invention:

| | |
|---|---|
| | (% by weight of the composition |
| Ingredient | unless stated otherwise) |

| | | |
|---|---|---|
| Example | 1 | 2 |
| Non-ionic surfactant mixture | 25 | 30 |
| (alcohol ethoxylated) | | |
| Anionic surfactant (LAS) | 15 | 10 |
| Sodium chloride | 1.1 | 1.2 |
| Sodium hydroxide | 0.2 | 1.6 |
| Thioxome S-9 | 7 | 10 |
| Perfume | 0.7 | 1 |
| Evozyme ® P500 BS7 | 1 × 10⁸ CFU/g | 1 × 10⁸ CFU/g |
| Minors and water | Up to 100% | Up to 100% |

Thioxome S-9: grafted copolymer of an acrylic polymer and fatty alcohol ethoxylates, from Guangzhou Tinci materials technology Co., Ltd. It contains 55% by weight of the grafted copolymer active.

Evozyme® P500 BS7: Bacillus spores, from Genesis Biosciences, Cardiff.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A concentrated laundry composition which is dilutable in water to form a liquid laundry detergent composition wherein the concentrated composition comprises:
a) from about 15 to about 85% by weight of surfactant;
b) a rheology modifier; and
c) from about 1×10² to about 1×10⁹ CFU/g of the composition of bacterial spores.

2. A concentrated laundry composition according to claim 1 wherein the composition comprises Bacillus spores.

3. A concentrated laundry composition according to claim 1 comprising Bacillus spores wherein the Bacillus is selected from the group consisting of Bacillus subtilis, Bacillus amyloliquefaciens, Bacillus licheniformis, Bacillus megaterium, Bacillus pumilus, Bacillus cereus, Bacillus thuringiensis, Bacillus mycoides, Bacillus tequilensis, Bacillus vallismortis, Bacillus mojavensis, and mixtures thereof.

4. A concentrated laundry composition according to claim 1 comprising Bacillus spores wherein the Bacillus is selected from the group consisting of Bacillus subtilis, Bacillus amyloliquefaciens, Bacillus licheniformis, Bacillus megaterium, Bacillus pumilus, and mixtures thereof.

5. A concentrated laundry composition according to claim 1 wherein the surfactant comprises a non-ionic surfactant, an anionic surfactant, or a mixture thereof.

6. A concentrated laundry composition according to claim 1 wherein the surfactant comprises an alcohol ethoxylate and an alkylbeneze sulfonate.

7. A concentrated laundry composition according to claim 1 wherein the composition comprises from about 25 to about 55% by weight of surfactant.

8. A concentrated laundry composition according to claim 1 wherein the composition comprises from about 5 to about 20% by weight of the rheology modifier.

9. A concentrated laundry composition according to claim 1 wherein the composition further comprises hydrogenated castor oil.

10. A concentrated laundry composition according to claim 1 wherein the rheology modifier comprises from 5 about to about 10% by weight of a grafted copolymer of an acrylic polymer and fatty alcohol alkoxylates, or its salts, or a mixture thereof.

11. A concentrated laundry composition according to claim 1 wherein the rheology modifier comprises an ethoxylated sorbitan ester.

12. A concentrated laundry composition according to claim 1 wherein the rheology modifier comprises a grafted copolymer of an acrylic polymer and fatty alcohol alkoxylates, or its salts, or a mixture thereof, and an ethoxylated sorbitan ester.

13. A concentrated laundry composition according to claim 1 wherein the rheology modifier comprises polyethylene glycol.

14. A concentrated laundry composition according to claim 1 wherein the rheology modifier comprises a grafted copolymer of an acrylic polymer and fatty alcohol alkoxylates, or its salts, or a mixture thereof, and polyethylene glycol.

15. A concentrated laundry composition according to claim 1 wherein the composition further comprises an enzyme.

16. A concentrated laundry composition according to claim 1 wherein the composition further comprises an adjunct comprising one or more of: peroxy compounds, bleach activators, anti-redeposition agents, neutralizers, optical brighteners, foam inhibitors, chelators, bittering agents, dye transfer inhibitors, soil release agents, water softeners, electrolytes, pH regulators, anti-graying agents, anti-crease components, bleach agents, colorants, scents, processing aids, and mixtures thereof.

17. A method of doing laundry comprising, measuring a predetermined amount of the concentrated laundry composition according to claim 1 and diluting the composition by a factor of 1 to 100, to form a diluted detergent and adding the dilute detergent to water to form a washing liquor.

18. The method of doing laundry of claim 17, wherein the composition is diluted by a factor of 8 to 12.

19. The method of doing laundry of claim 18, wherein the washing liquor comprises at least 1×10² CFU/liter of the liquor, of bacterial spores.

20. The method of doing laundry of claim 18, wherein the bacterial spores comprise Bacillus spores and the washing liquor comprises from about 1×10⁴ to 1×10⁷ CFU/liter of the liquor, of the Bacillus spores.
